(19) United States
(12) Patent Application Publication
(10) Pub. No.: US 2020/0221765 A1
(43) Pub. Date: Jul. 16, 2020

(54) CONSUMABLE PACKAGE FOR COMBUSTIBLE PLANT-BASED MATERIAL

(71) Applicant: Callections LLC, Alpharetta, GA (US)

(72) Inventor: Clint R. Winter, Alpharetta, GA (US)

(21) Appl. No.: 16/502,398

(22) Filed: Jul. 3, 2019

Related U.S. Application Data
(60) Provisional application No. 62/790,662, filed on Jan. 10, 2019.

(51) Int. Cl. A24F 23/00; A24B 15/16; B65D 85/00; B65D 25/34; B65D 71/72; A61J 1/00

(52) U.S. Cl. CPC A24F 23/00; A24B 15/167; A61J 1/00; B65D 25/34; B65D 71/72; B65D 85/70

(57) ABSTRACT

A package including a body portion, a sealing portion, and a combustible plant-based material is disclosed. The body portion can include a combustible or burnable material.

### CROSS-REFERENCE TO RELATED APPLICATIONS

This application claims the benefit, under 35 U.S.C. § 119(e), of U.S. Provisional Patent Application No. 62/790,662, filed 10 Jan. 2019, the entire contents and substance of which is incorporated herein by reference in its entirety as if fully set forth below.

### BACKGROUND

Burning substances in small quantities to produce a vapor of said substance continues to be a ubiquitous aspect of daily life. A wide variety of applications for producing vapor from burning substances are desired. In some cases, vapors produced from burning a substance are desired for certain health effects. Whether the vapor is meant to be inhaled, produce an aroma, or improve health, substances continue to be burned regularly around the world for any number of reasons. Improved methods and packages for burning such substances are desirable. The presently disclosed technology addresses this need as well as other needs that will become apparent upon reading the description below in conjunction with the drawings.

### SUMMARY

The present disclosure relates generally to a consumable (i.e., by a human) package for a combustible plant-based material or substance, and, more particularly, to a preformed and proportioned package for burning an organic material to be heated, combusted, burned, smoldered, and/or vaporized. As will be appreciated, the consumable package can itself be heated, combusted, burned, smoldered, and/or vaporized and can be smoked, inhaled or otherwise consumed by a user as the user smokes, inhales, or otherwise consumes the combustible plant-based material.

Aspects of the present disclosure relate to a package configured to hold, envelop, and/or contain a combustible, plant-based material. This may be beneficial for various applications in which users smoking or otherwise inhale the combustible, plant-based material. The package can include a body portion, and the body portion can comprise a combustible and/or burnable material. As an example, the package can comprise a paper or paper-like material. The body portion can form or otherwise include an interior void. The body portion can be sized and/or dimensioned such that the inner void can substantially house a predetermined amount of a material, such as a predetermined portion of the combustible, plant-based material. The package can have a shape and size that are substantially similar to, and/or fitted to be at least partially insertable into, an apparatus in which the package and/or combustible plant-based material is to be combusted and/or burned. The package can be configured to have a predetermined vertical cross-sectional shape. The package can be configured to have a predetermined horizontal cross-sectional shape. The package can be configured to have a predetermined three-dimensional shape. For instance, the package can be configured to have a substantially conical shape, a substantially frustoconical shape, a substantially hemispherical shape, a rectangular prism, or a cylindrical prism.

The package can comprise a sealing portion configured to attach to the package. The sealing portion can be configured to attach to the package such that the combustible plant-based material can be substantially enveloped and/or contained within the interior void of the package. As non-limiting examples, the sealing portion can comprise at least one of paper, organic material, plastic, foil (e.g., aluminum foil), and the like. The sealing portion can include one or more materials that are not combustible. Alternately, the sealing portion can include one or more materials that are easily combustible. The sealing portion can be configured to detachably attach (e.g., detachably seal) with at least one surface of the package. The sealing portion can be configured to temporarily seal one or more apertures or openings of the packaging. For example, the sealing portion can be configured to function as a removable lid to the package. The sealing portion can be configured to permanently seal one or more apertures or openings of the packaging. For example, the sealing portion can be configured to function as a non-removable lid to the package. The package can include a first sealing portion configured to temporarily seal one or more apertures or openings of the packaging and a second sealing portion configured to permanently seal one or more apertures or openings of the packaging. The sealing portion can include a combustible or burnable material. The package can include an adhesive or some other material configure to adhere and/or attach the sealing portion to the body portion of the package. The adhesive can be configured to permanently or temporarily attach the sealing portion to the body portion of the package.

The body portion, sealing portion, and/or adhesive can include one or more materials that prevent transfer of moisture and/or air into the interior void of the package. This can encourage or otherwise help provide a long shelf life for a combustible, plant-based material disposed within the package. Stated otherwise, the material(s) of the body portion, sealing portion, and/or adhesive can be selected such that the combustible material disposed in the interior void of the package can remain dry and/or fresh.

The burnable material can comprise a plant or tree-based substance. For instance, the plant-based substance can comprise tobacco, hemp, marijuana, myrrh, incense, or a combination thereof, among other applicable substances. Also disclosed herein are methods for use and operation of the package containing a burnable material.

### BRIEF DESCRIPTION OF THE DRAWINGS

The accompanying drawings, which are incorporated in and constitute a part of this specification, illustrate multiple examples of the presently disclosed subject matter and serve to explain the principles of the presently disclosed subject matter. The drawings are not intended to limit the scope of the presently disclosed subject matter in any manner.

FIG. 1A is a perspective view of an example package, according to the presently disclosed technology;

FIG. 1B is a perspective view of an example package, according to the presently disclosed technology;

FIG. 2 is perspective view of an example package, according to the presently disclosed technology;

FIG. 3A is a perspective view of an example package, according to the presently disclosed technology;

FIG. 3B is a top isometric view of an example package, according to the presently disclosed technology;

FIG. 4 depicts a non-exhaustive list of cross-sectional shapes of an example package, according to the presently disclosed technology;

FIG. 5A is a perspective view of an example packaging, according to the presently disclosed technology;

FIG. 5B is a perspective view of an example packaging including a lid, according to the presently disclosed technology; and

FIG. 5C is a side perspective view of an example packaging including a lid, according to the presently disclosed technology.

### DETAILED DESCRIPTION

Although certain examples of the disclosed technology are explained in detail, it is to be understood that other embodiments are contemplated. Accordingly, it is not intended that the disclosure is limited in its scope to the details of construction and arrangement of components set forth in the following description or illustrated in the drawings. Other embodiments and examples of the disclosed technology are capable of being practiced or carried out in various ways. Also, in describing the disclosed technology, specific terminology will be resorted to for the sake of clarity. It is intended that each term contemplates its broadest meaning as understood by those skilled in the art and includes all technical equivalents which operate in a similar manner to accomplish a similar purpose.

It should also be noted that, as used in the specification and the appended claims, the singular forms “a,” “an” and “the” include plural references unless the context clearly dictates otherwise. References to a composition containing “a” constituent is intended to include other constituents in addition to the one named.

Ranges may be expressed herein as from “about” or “approximately” or “substantially” one particular value and/or to “about” or “approximately” or “substantially” another particular value. When such a range is expressed, the disclosed technology includes values from the one particular value and/or to the other particular value.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

As used herein, the term “combustible” refers to materials able to undergo at least a partial combustion or smoldering reaction under atmospheric conditions when exposed to an ignition source, such as a spark or a flame. As used herein, “flammable” can be used to describe a material that is able to ignite being exposed to a flame under atmospheric conditions at room temperature. As would be appreciated by one of ordinary skill in the art, a package comprising a substantially flammable material would provide a constant flame source for the ignition of the burnable material contained within the interior void of the package. The substantially flammable material can be a nonflammable material that is mixed or coated with a flammable material to impart the property of flammability to the package.

It is also to be understood that the mention of one or more method steps does not preclude the presence of additional method steps or intervening method steps between those steps expressly identified. Moreover, although the term “step” may be used herein to connote different aspects of methods employed, the term should not be interpreted as implying any particular order among or between various steps herein disclosed unless and except when the order of individual steps is explicitly required.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Combusting and/or burning substances in a controlled environment and inhaling or otherwise consuming such combusting and/or burning substances can have a desirable impact on a user's daily life. Substances could be burned for a variety of reasons. Examples can include incense (e.g., for religious or recreational purposes), oils (e.g., for medicinal or recreational purposes), and plant-based combustible materials (e.g., for medicinal or recreational purposes). Regarding plant-based combustible materials, it can be advantageous for a predetermined amount of the plant-based combustible material to be provided. This can facilitate easy and convenient use for a user. Such a system can be particularly useful in medical applications where specific, predetermined dosages of a particular material or substance are desired.

Existing systems for heating, combusting, burning, smoldering, and/or vaporizing a plant-based combustible material for user inhalation and/or consumption can include heating combusting, burning, smoldering, and/or vaporizing the plant-based combustible material in a non-combustible smoking apparatus or in a cigarette. Cigarettes, however, are generally limited to tobacco. Further, cigarettes may not provide specific or accurate predetermined amounts a plant-based combustible material. Further still, cigarettes may provide significant waste disposal issues as cigarettes can be a significant source of littering. In addition, heating, combusting, burning, smoldering, and/or vaporizing a plant-based combustible material in a non-combustible smoking apparatus (e.g., hookah, pipe, bong, bowl) may require a user to perform cumbersome and burdensome steps prior to smoking, inhaling, or otherwise consuming the smoke, particles, vapors, and/or chemicals from the combusting plant-based material. For example, a user may be required to perform at least one of the following steps: removing desired plant-based material (e.g., leaves) from undesired plant-based material (e.g., sticks, stems), grinding the plant-based material into a desired size and/or consistency, and loading the plant-based material into a heating area of the smoking apparatus. As will be appreciated, preparing the plant-based material can be a messy process, which may be undesirable for many users. As will also be appreciated, loading the plant-based material into the heating area of the smoking apparatus may be difficult and/or cumbersome, for example, due to the small size of the plant-based material, whether the plant-based material is ground or not.

The present disclosure relates to packages providing a proportioned, predetermined, and/or controlled amount of a desired combustible plant-based material. The present disclosure can be configured to facilitate easy consumption of the combustible plant-based material by a user. The present disclosure can alleviate the need for a user to portion and control the substance prior to use. Accordingly, the present disclosure can provide a system facilitating simple, clean, and amount-controlled smoking, inhalation, or other consumption of a plant-based combustible material.

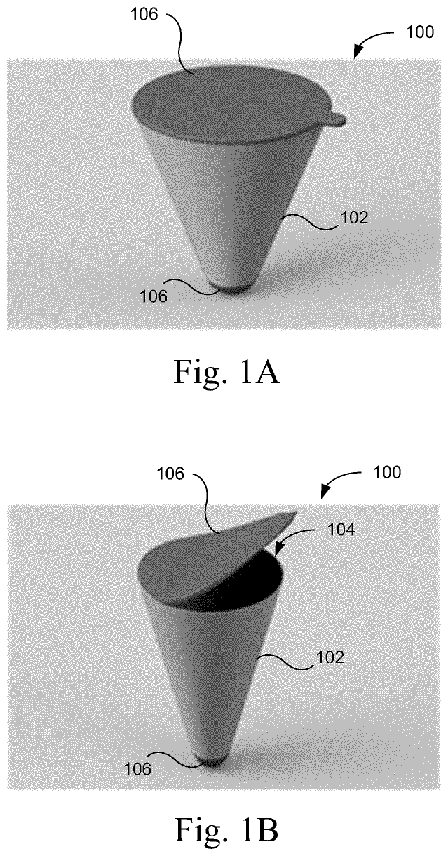

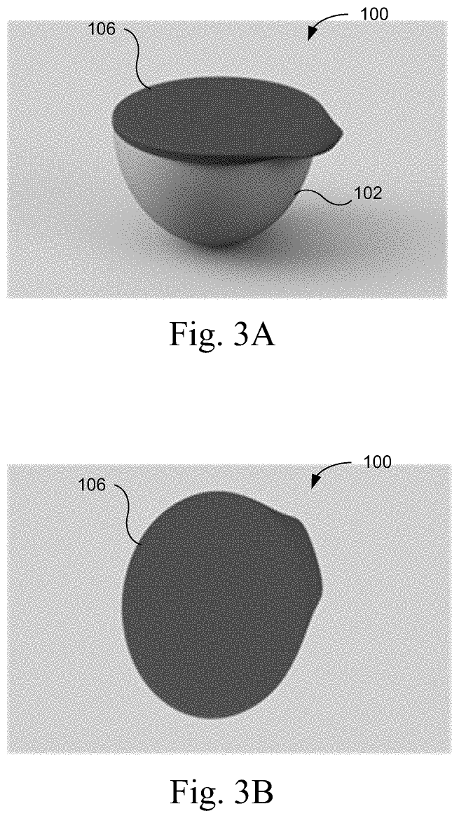

Referring to FIGS. 1A-3B, the present disclosure includes a package 100 including a combustible plant-based material or substance 110. The package 100 can include a body portion 102. The body portion 102 can include an interior void 104, and the interior void 104 can be configured to substantially hold a predetermined amount of a combustible plant-based material 110. The combustible plant-based material 110 can include, as non-limiting examples, tobacco, hemp, cannabis, frankincense, sage, myrrh, sandalwood, white sage, rose, lavender, jasmine, champaka petals, magnolia, cinnamon, patchouli, lemongrass, amber, cedar, balsam, bayberry, citronella, eucalyptus, gardenia, honeysuckle, hyacinth, rosemary, vanilla, or a combination thereof. The combustible plant-based material 110 can include solid materials and/or can include liquid or semi-liquid materials. For example, the combustible plant-based material 110 can include one or more concentrates, keef, tinctures, wax resin, hash oil, cannabis oil, CBD oil, other herbal oils, and the like.

The package 100 can include multiple combustible plant-based materials 110. The multiple combustible plant-based materials 110 can be layered according to a predetermined scheme. The predetermined scheme can include the combustible plant-based materials 110 arranged in a configuration such that the materials combust in a predetermined order. As will be appreciated, this can influence the user experience during consumption. For example, the package 100 can include a predetermined amount of keef at the bottom of the interior void 104 and can include a predetermined amount of leafy cannabis atop the keef and within the interior void 104.

The body portion 102 can include one or more (e.g., one, two, three, four, five, six, or more) dividers within the interior void 104. Thus, instead or in addition to layering multiple combustible plant-based materials 110, multiple combustible plant-based materials 110 can be disposed within separate sections formed by the divider(s). For example, if the body portion 102 includes a single divider, a first combustible plant-based material 110 can be disposed within a first section of the interior void 104 on a first side of the divider and a second combustible plant-based material 110 can be disposed within the adjacent second section of the interior void 104 on the opposite side of the divider. As another example, if the body portion 102 includes two dividers, a first combustible plant-based material 110 can be disposed within a first section of the interior void 104, a second combustible plant-based material 110 can be disposed within a second section of the interior void 104, and a third combustible plant-based material 110 can be disposed within a third section of the interior void 104. The divider(s) can be positioned such that the volume of each section is equal or substantially equal. Alternately, the divider(s) can be positioned such that some or all of the sections have different volumes. This can permit numerous combinations of types and amounts of multiple types of combustible plant-based materials 110.

The body portion 102 (and optionally, the divider) can comprise a substantially combustible, flammable, and/or burnable material. The body portion 102 of the package 100 can comprise paper or a paper derivative. As non-limiting examples, the body portion 102 can include banana paper, bond paper, book paper, construction paper, sugar paper, cotton paper, kraft paper, laid paper, leather paper, mummy paper, sandpaper, wallpaper, wax paper, filter paper, rolling paper, rag fiber paper, flax paper, hemp paper, sisal paper, rice paper, esparto paper, cigarette paper, or a combination thereof. Alternately or in addition, the body portion 102 can comprise a woven material or a nonwoven material.

The body portion 102 can comprise the combustible plant-based material 110 itself. For example, the body portion 102 can include a combination of the combustible plant-based material 110 and paper or a paper derivative. Alternately or in addition, the body portion 102 can include the combustible plant-based mixed with a filler material. Alternately, the body portion 102 can consist or substantially consist of the combustible plant-based material 110. As an example in which the body portion 102 includes the combustible plant-based material 110, the combustible plant-based material 110 can be pressed or otherwise configured to form or substantially form the body portion 102. The body portion 102 can include an interior void 104. For example, the body portion 102 can comprise an amount of the combustible plant-based material 110 formed (e.g., compressed) into a shape (e.g., a sphere, hemisphere, cube, cone, frustum, or some other shape) that does not include an interior void. As another example, the body portion 102 can comprise an amount of the combustible plant-based material 110 formed (e.g., compressed) into a shape including an interior void 104. The body portion 102 (which can include an amount of the combustible plant-based material 110 formed into a shape including an interior void) can include an amount of the combustible plant-based material 110 within the interior void 104. The amount of the combustible plant-based material 110 within the interior void 104 can be substantially uncompressed (i.e., not affirmatively compressed). That is, the body portion 102 can include a first amount of the combustible plant-based material 110 and can form an interior void 104 that can include a second amount of the combustible plant-based material 110.

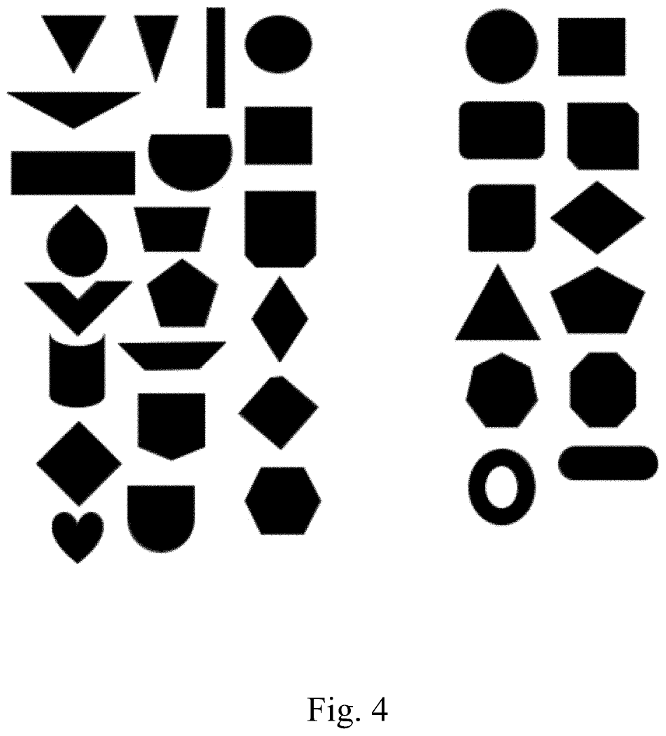

The package 100 can be substantially formed to the size and shape of an apparatus in which the combustible plant-based material 110 is to be heated, combusted, burned, smoldered, and/or vaporized. For example, the package 100 can be configured to substantially fit into a heating area of a hookah, pipe, bong, bowl, or some other smoking apparatus. The package 100 can have any desired shape. The package 100 can be configured to have a predetermined vertical cross-sectional shape. The package 100 can be configured to have a predetermined horizontal cross-sectional shape. Non-limiting examples of cross-sectional shapes are depicted in FIG. 4. The package can be configured to have a predetermined three-dimensional shape. As examples, the package can be configured to have a substantially conical shape, a substantially frustoconical shape, or a substantially hemispherical shape. As additional examples, the package can be in the shape of a cube, rectangular prism, triangular prism, sphere, or egg-shape. As further examples, the package can have a cross-section substantially in the shape of a square, rectangle, circle, oval, parallelogram, trapezoid, pentagon, hexagon, octagon, heart, bow, doll, baby, tube of lipstick, crown, ring, necklace, hat, watch, backpack, shopping bag, birthday cake, ice cream, hamburger, balloon, telephone, mailbox, house, stove, oven, dishwasher, lightning bolt, Christmas tree, menorah, bicycle, tricycle, car, truck, train, plane, boat, rocket, spaceship, flower, tree, animal (such as, but not limited to, a cat, mouse, dog, fish, bird, horse, penguin, monkey, octopus, butterfly, dolphin, whale, camel, elephant, rhinoceros, lion, reindeer, and unicorn), baseball bat, football, shoe, snowman, pumpkin, angel, cloud, star, moon, character (e.g., clown, cartoon, Santa Claus), musical instrument (such as, but not limited to, a saxophone, piano, trumpet, drums, violin, guitar), television, hammer, screwdriver, leaf, plant, or any other suitable shape.

The package 100 can include one or more openings or apertures. The package 100 can include a top aperture and/or can include a bottom aperture. As will be appreciated by one of ordinary skill in the art, including both a top aperture and a bottom aperture can facilitate burning of combustible plant-based material 110 included within the package 100, such as by permitting circulation of air to provide fuel to the burning of the combustible plant-based material 110 within the package and/or by permitting vapor to escape from the interior void 104 of the package 100. The package 100 may, however include a single aperture or no apertures at all.

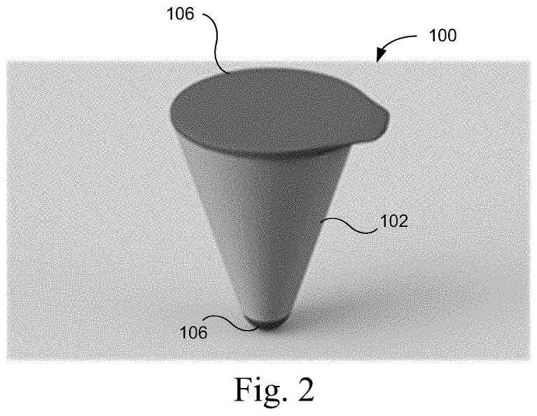

Referring to FIGS. 1A-2, the package 100 can have a frustoconical shape. The package 100 can have a height, a first (e.g., top) face having a first diameter, and a second (e.g., bottom) face having a second diameter. The second diameter can have a smaller diameter than the first diameter. That package 100 can include a filter material proximate at least one of the first face or the second face, and the filter material can be configured to permit vapor to pass only through the first face or the second face, as desired.

The package 100 can comprise a sealing portion 106 configured to attach to the body portion 102. The sealing portion 106 can be configured to attach to the body portion 102 such that the combustible plant-based material 110 can be substantially enveloped and/or contained within the interior void 104 of the package 102. As non-limiting examples, the sealing portion 106 can comprise at least one of paper, organic material, plastic, foil (e.g., aluminum foil), and the like. The sealing portion 106 can include one or more materials that are not combustible and/or not desired to be combusted or inhaled. For example, the sealing portion 106 can include foil (e.g., aluminum foil), paper, parafilm, cellophane, parchment paper, vinyl, a combination thereof, or any material able to substantially seal with the package such that the burnable material contained in the interior void of the package can remain dry and fresh.

The sealing portion 106 (e.g., lid) can be configured to detachably attach (e.g., detachably seal) with at least one surface of the package 100. For example, the sealing portion 106 can be configured to attach to a perimeter of the body portion 102 surrounding one or more apertures of the body portion 102. The sealing portion 106 can be configured to temporarily seal one or more apertures or openings of the body portion 102. For example, the sealing portion 106 can be configured to function as a removable lid to the package 100. The sealing portion 106 can include a tab to facilitate easy removal of the sealing portion 106 from the body portion 102.

Alternately, the sealing portion 106 can be configured to permanently seal one or more apertures or openings of the body portion 102. For example, the sealing portion 106 can be configured to function as a non-removable lid to the package 100. The package 100 can include a first sealing portion 106 configured to temporarily seal one or more apertures or openings of the body portion 102 and a second sealing portion 106 configured to permanently seal one or more apertures or openings of the body portion 102. The sealing portion 106 can include one or more materials that are easily combustible. As will be understood, the sealing portion 106 can include materials that do not necessarily prevent transfer or moisture or air into the package 100 but can include materials that are desirable to be burned or combusted and inhaled. Accordingly, the sealing portion can be permanently attached to the package 100 and can be configured to be heated, burned, combusted, vaporized, or otherwise used with the rest of the package 100.

Alternately or in addition, one or more sections of the sealing portion 106 can be selectively removeable. For example, a first section of the sealing portion 106 (e.g., half of the sealing portion, a third of the sealing portion) can be removed from the package 100, while a second section of the sealing portion 106 remains attached to the package 100. The second section of the sealing portion 106 can be permanently attached to the package 100 or can be selectively removeable from the package 100.

The package 100 can include an adhesive or some other material configure to adhere and/or attach the sealing portion 106 to the body portion 102. The adhesive can be configured to permanently or temporarily attach the sealing portion 106 to the body portion 102. As shown in FIGS. 1A-2, the package 100 can include one or more sealing portions 106 configured to cover two or more apertures. For example, the package 100 can include a first sealing portion 106 (e.g., a lid) configured to cover a top opening of the package 100 and can include a second sealing portion 106 (e.g., a tip) configured to cover a bottom opening of the package 100. Alternately, the first sealing portion 106 and the second sealing portion 106 can be connected to facilitate easy removal of both sealing portions 106.

The body portion 102, sealing portion 106, and/or adhesive can include one or more materials that prevent transfer of moisture and/or air into the interior void of the package 100. This can encourage or otherwise help provide a long shelf life for a combustible, plant-based material disposed within the package. Stated otherwise, the material(s) of the body portion 102, sealing portion 106, and/or adhesive can be selected such that the combustible plant-based material 110 of the package 100 can be preserved and/or remain dry and/or fresh.

The package 100 (or any portion thereof, e.g., the body 102) can include perforations, which can help facilitate combustion within the package. That is, the perforations can encourage airflow through and/or into the interior of the package 100 to encourage combustion. The package 100 can include perforations in one or more portions of the body. For example, the body portion 102 can include perforations on a side of the body portion 102. As a further example, the body portion 102 can include another group of perforations on an opposite and/or adjacent side of the body portion 102. The amount, size, and location of the perforations on the package 100 can be predetermined to maximize combustion within the package and/or to encourage a desired burn rate or burn pattern within the package 100. For example, the perforations can encourage certain areas with the package 100 to burn or combust in a predetermined order.

The package 100 can include a protective film enclosing, or at least substantially enclosing the package 100. The protective film can be configured to provide a substantially air impermeable and/or moisture impermeable barrier. The protective film can be a foil, a plastic, cellophane, shrink-wrap, plastic wrap, or some other film. The material(s) of the protective film can be selected such that the combustible plant-based material 110 of the package 100 can be preserved and/or remain dry and/or fresh. The package 100 can include the protective film in addition to the sealing portion 106. Alternatively, the package 100 can include the protective film and no sealing portion.

The package 100 (or any portion thereof, e.g., the body 102) can include flavoring. A non-limiting list of example flavors includes fruit flavors (e.g., grape, banana, kiwi, pineapple, apple, orange, lemon, lime, coconut, strawberry, raspberry, blackberry, blueberry), nutty flavors (e.g., peanut, almond, walnut, cashew, hazelnut, pistachio, pecan), sweets flavors (e.g., chocolate, vanilla, caramel), or any other desired flavor or combination thereof. The flavoring can be imparted to the package 100 via a liquid, oil, solid, or any other material infused with the flavoring, and the material (e.g., a portion of the package 100) can be sprayed, dipped, submerged, layered, impregnated, or otherwise exposed to a flavored composition such that the material retains the corresponding flavor.

Alternately or in addition, the package 100 (or any portion thereof, e.g., the body 102) can include a scent. A non-limiting list of example scents includes fruit scents (e.g., grape, banana, kiwi, pineapple, apple, orange, lemon, lime, coconut, strawberry, raspberry, blackberry, blueberry), nutty scents (e.g., peanut, almond, walnut, cashew, hazelnut, pistachio, pecan), sweets scents (e.g., chocolate, vanilla, caramel), or any other desired scents or combination thereof. The scent can be imparted to the package 100 via a liquid, oil, solid, or any other material providing a fragrant effect. The package 100 can include a fragrant coating. For example, the package 100 can include topical “scratch and sniff” technology (e.g., a fragrant coating that, when disturbed such as by scratching, releases a particular odor). Alternately or in addition, the package 100 can include a fragrant composition configured to be released during burning and/or combustion. Thus, the fragrant composition of the package 100 can be released to supplement any fragrances or scents released by burning and/or combustion of the combustible plant-based material 110 and/or package 100 itself. A material (e.g., a portion of the package 100) can be sprayed, dipped, submerged, layered, impregnated, or otherwise exposed to a fragrant composition such that the material retains the corresponding fragrance and/or at least a portion of the fragrant composition.

The package 100 can include one or more colors. Various portions of the package 100 can each have a color, and these colors can be the same or different for one, some, or all of the various portions of the package 100. The colors of the package 100 can follow a theme. For example, the package 100 can be yellow to coincide with the package 100 having a banana flavoring and/or scent. The package 100 can include various images, text, or other marks, which can be beneficial for marketing and/or identification purposes.

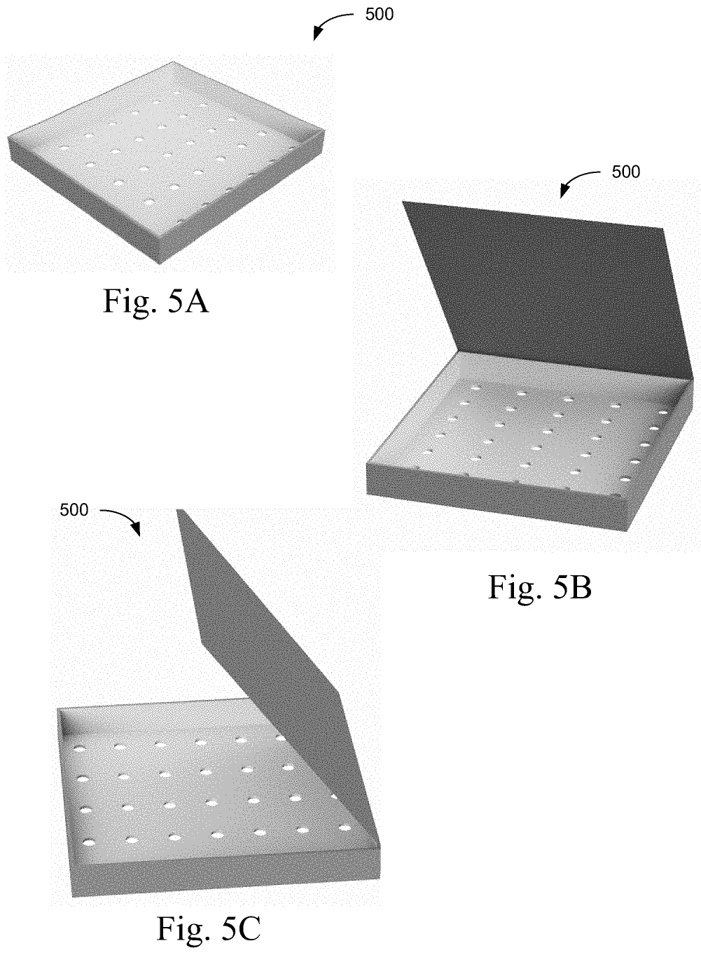

Referring to FIGS. 5A-5C, a container or packaging 500 can be provided. The packaging 500 can be configured to temporarily house or envelop one or more packages 100. The packaging 500 can be configured to provide a predetermined number of packages 100, for example, according to a predetermined number of doses of combustible plant-based material 110 included in each package 100. The packaging 500 can include depressions (e.g., in a bottom surface of the packaging 500), holes, apertures, or cutouts, where each hole, aperture, or cutout is configured to at least partially receive a package 100. Alternately or in addition, the packaging can include an insert including holes, apertures, or cutouts, where each hole, aperture, or cutout is configured to at least partially receive a package 100. As will be appreciated, the holes, apertures, or cutouts (whether disposed in an insert or in the packaging 500 itself) can be configured to maintain the packages 100 in a predetermined position and orientation within the packaging 500.

The packaging 500 can be configured to be reusable and/or resealable. For example, the packaging 500 can include a lid that can be detachably attached to a base of the packaging (e.g., a base configured to house packages 100, such as described above). Alternately or in addition, the lid can releasably seal a top portion of the base. As will be appreciated, combustible plant-based materials 110 generally have a relatively low mass as compared to shipping and/or storage container in which the combustible plant-based materials 110 are typically stored. Thus, by providing a reusable and/or resealable packaging 500, a reduced environmental impact of the packaging 500 can be provided (e.g., by reducing the amount of waste incurred by use of the packaging 500 and/or one or more packages 100). While in a closed configuration, the packaging 500 can be configured to provide a substantially air impermeable and/or substantially moisture impermeable barrier and/or seal. Accordingly, the packaging 500 can be configured to provide an interior environment in which one or more packages 100 or other items can be preserved and/or remain dry and/or fresh.

The packaging 500 can include a lock or other securing mechanism such that certain persons (e.g., minors, children) can be prevented from accessing the package(s) 100 inside the packaging 500. The securing mechanism can be connected to the lid of the packaging 500. The lid can be hingedly attached to the base of the packaging 500, and the securing mechanism can be a lock (e.g., a lock accessible by a key, an analog combination lock accessible by entry of a particular combination, a digital combination lock accessible by entry of a particular combination, a digital biometric locking mechanism accessible by a particular user's biometric information), or any other useful mechanism or device configured to secure and prevent entry to the inside of the packaging 500.

While the present disclosure has been described in connection with a plurality of exemplary aspects, as illustrated in the various figures and discussed above, it is understood that other similar aspects can be used, or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

What is claimed is:

1. A consumable package comprising:
a body portion comprising a bottom, at least one side, and an opening defined by an edge of the at least one side, the bottom and at least one side defining an internal void;
a combustible plant-based material disposed within the internal void; and
a sealing portion configured to attach to the edge of the at least one side.

2. The consumable package of claim 1, wherein the body portion has a substantially conical shape, a substantially frustoconical shape, or a substantially hemispherical shape.

3. The consumable package of claim 1, wherein the body portion comprises a material that is substantially combustible, substantially flammable, and/or substantially burnable.

4. The consumable package of claim 3, wherein the body portion comprises at least one of a paper, a woven material, and a non-woven material.

5. The consumable package of claim 1, wherein the body portion comprises the combustible plant-based material.

6. The consumable package of claim 1, wherein:
the combustible plant-based material is a first combustible plant-based material,
the consumable package further comprises a second combustible plant-based material,
the body portion further comprises a divider,
a first section of the internal void is defined by the divider and a first portion of the at least one side of the body portion,
a second section of the internal void is defined by the divider and a second portion of the at least one side of the body portion,
the first combustible plant-based material is disposed within the first section of the internal void, and
the second combustible plant-based material is disposed within the second section of the internal void.

7. The consumable package of claim 1, wherein the combustible plant-based material is a first combustible plant-based material, the consumable package comprises a second combustible plant-based material that is different from the first combustible plant-based material, and the second combustible plant-based material is layered atop the first combustible plant-based material.

8. The consumable package of claim 1, wherein the combustible plant-based material comprises a solid material.

9. The consumable package of claim 1, wherein the combustible plant-based material comprises a liquid material or a semi-liquid material.

10. The consumable package of claim 1, wherein at least one of the bottom and the at least one side comprises perforations.

11. The consumable package of claim 1, wherein the sealing portion is detachably attached to the edge of the at least one side.

12. The consumable package of claim 1, wherein the sealing portion is permanently attached the edge of the at least one side and the sealing portion comprising a combustible material.

13. The consumable package of claim 1, wherein the bottom of the body portion comprises an aperture and a tip covering the aperture, the tip being removably attached to the bottom of the body portion.

14. The consumable package of claim 1, wherein the body portion comprising a scented coating.

15. The consumable package of claim 1 further comprising a flavoring.

16. A consumable package comprising:
a body portion having a bottom and at least one side including an edge opposite the bottom, the body portion comprising a combustible plant-based material,
wherein the body portion has a shape and size configured to complement a predetermined smoking apparatus.

17. The consumable package of claim 16, wherein the combustible plant-based material is compressed to form the body portion.

18. A container comprising:
a base comprising a plurality of holding locations, each holding location disposed on an inner bottom surface of the packaging;
a lid configured to releasably seal a top portion of the base; and
a plurality of consumable packages, each consumable package comprising:
a body portion comprising a bottom, at least one side, and an opening defined by an edge of the at least one side, the bottom and at least one side defining an internal void;
a combustible plant-based material disposed within the internal void; and
a sealing portion configured to attach to the edge of the at least one side,
wherein each holding location is configured to receive a consumable package of the plurality of consumable packages.

19. The container of claim 18, wherein at least some of the plurality of holding locations are apertures.

20. The container of claim 18, wherein at least some of the plurality of holding locations are depressions.
